(19) United States
(12) Patent Application Publication
(10) Pub. No.: US 2011/0169209 A1
(43) Pub. Date: Jul. 14, 2011

(54) PRINTING DEVICE

(75) Inventors: CHEN-LU FAN, Tu-Cheng (TW); CHIH-KUN SHIH, Santa Clara, CA (US); CHUN-HSIEN LIN, Tu-Cheng (TW)

(73) Assignee: HON HAI PRECISION INDUSTRY CO., LTD., Tu-Cheng (TW)

(21) Appl. No.: 12/858,438

(22) Filed: Aug. 18, 2010

(30) Foreign Application Priority Data
Jan. 13, 2010 (CN) 201010300212.3

(51) Int. Cl. B41L 43/12; B65H 1/00

(52) U.S. Cl. 270/58.11; 271/264

(57) ABSTRACT

A printing device includes a main body and a paper holding device. The main body is capable of printing and dispensing paper. The paper holding device is secured to the main body and includes a bracket, a paper tray, a paper adjusting mechanism, and a punch mechanism. The bracket is secured to the main body. The paper tray is secured to the bracket for receiving the dispensed paper. The paper adjusting mechanism is capable of aligning the dispensed paper. The punch mechanism is capable of binding the dispensed paper. The main body dispenses the paper between the paper adjusting mechanism and the punch mechanism.

### BACKGROUND

1. Technical Field

The present disclosure relates to a device capable of printing, collating and neatly aligning the printed file.

2. Description of Related Art

In a printing device, paper is dispensed to a paper tray. However, some print jobs may involve many sheets and will not be neatly aligned in the tray and require a user to manually align the sheets. So, a printing device that is capable of neatly dispensing the dispensed paper is needed.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded view of a paper holding device of a printing device in accordance with an embodiment.

FIG. 2 is another isometric view of a paper adjusting mechanism of FIG. 1.

FIG. 3 is similar to FIG. 2, but shows first and second sliding blocks in another position.

FIG. 4 is another isometric view of the paper adjusting mechanism of FIG. 1.

FIG. 5 is similar to FIG. 4, but shows a pushing block in another position.

FIG. 6 is similar to FIG. 5, but viewed in another aspect.

FIG. 7 is assembled view of the paper holding device of FIG. 1.

FIG. 8 is similar to FIG. 7, but shows a mounting board and a plurality of paper trays secured to the paper holding device.

FIG. 9 is similar to FIG. 8, but viewed in another aspect.

FIG. 10 is an assembled view of the printing device.

FIG. 11 is similar to FIG. 10, but showing the paper trays in another position.

FIG. 12 is similar to FIG. 11, but showing the paper trays in another position.

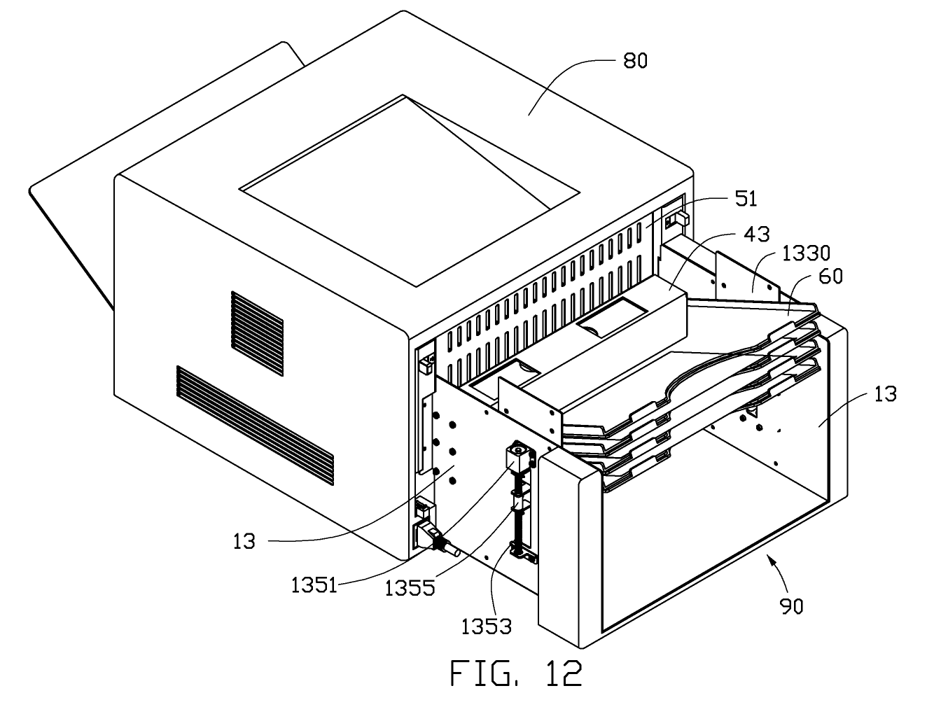

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

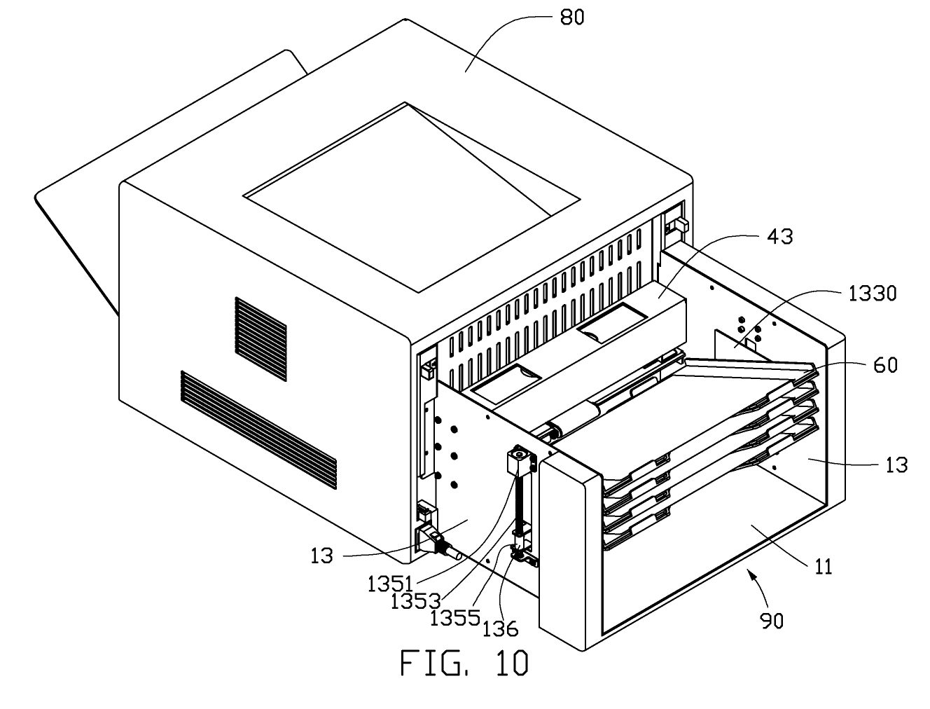

Referring to FIG. 10, a printing apparatus in accordance with an embodiment includes a main body 80, and a paper holding device 90 configured for being secured to the main body 80. The main body 80 is capable of printing and dispensing paper to the paper holding device 90.

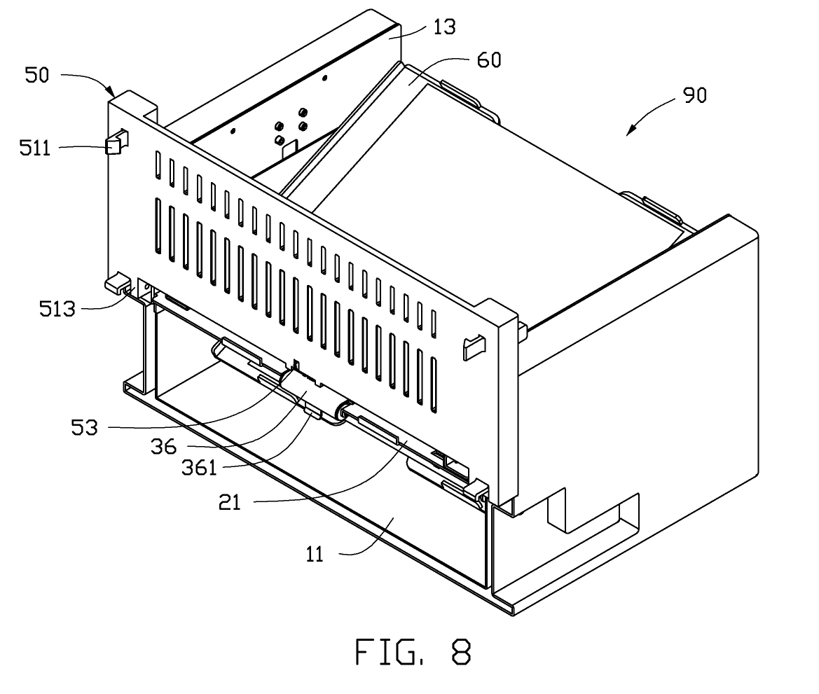

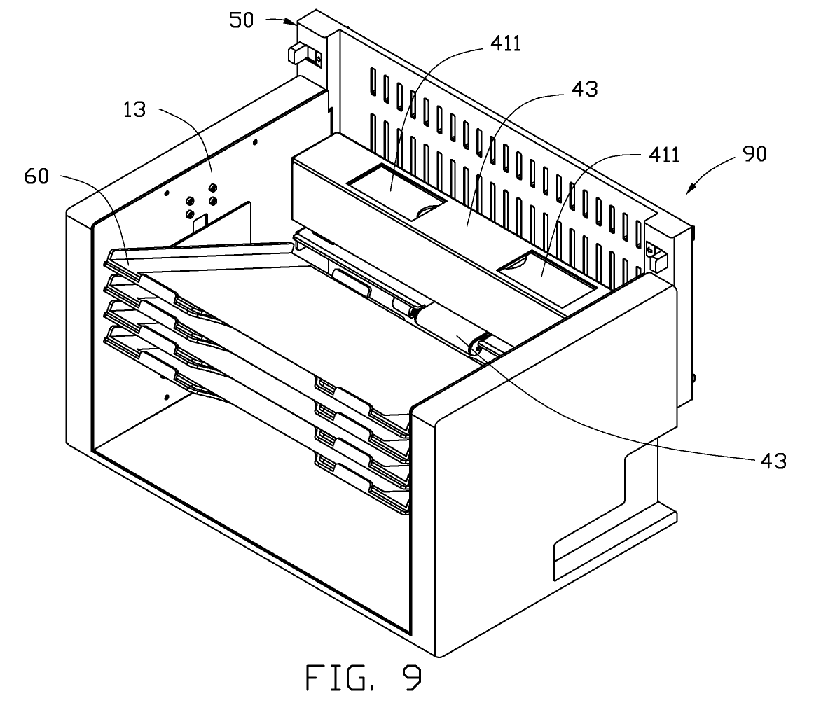

The paper holding device 90 includes a bracket 10, a paper adjusting mechanism 20, a punch mechanism 40, and a plurality of paper trays 60 (shown in FIGS. 8-9).

The bracket 10 includes a bottom plate 11 and two side plates 13 located on opposite edges of the bottom plate 11. Each side plate 13 defines a plurality of mounting holes 131, adjacent a rear edge thereof, and a through opening 132 in front of the mounting holes 131. A first driving mechanism 135 is secured to each side plate 13. Each driving mechanism 135 includes a sliding piece 133, a first motor 1351, a connecting shaft 1353, and a sliding member 1355. The sliding pieces 133 are secured to inner surfaces of the side plates 13. The first motors 1351 are secured to outer surfaces of the side plates 13 at a top side of the through openings 132. The shafts 1353 are secured to the first motors 1351 and can be rotated by the first motors 1351. The sliding member 1355 are secured to the shafts 1353 and can be slid on the shafts 1353 when the shafts 1353 are rotated. In one embodiment, the sliding members 1355 are threadly engaged with the shafts 1353. The sliding members 1355 are fixed on the sliding pieces 133 with fasteners, such as screws (not shown), utilizing the through openings 132. A mounting member 136 is secured to each side plate 13 at a bottom side of the through opening 132 and engaged with the corresponding connecting shaft 1353. A plurality of pairs of securing holes 1331 is defined in each sliding piece 133. An angle is defined between the bottom plate 11 and a line defined by each pair of securing holes 1331. The angle is greater zero degrees but less than 90 degrees. Each pair of securing holes 1331 is configured to secure one paper tray 60 by fasteners, such as screws (not shown). In one embodiment, a cover 137 is secured to outside of the bracket 10 to cover the first driving mechanisms 135.

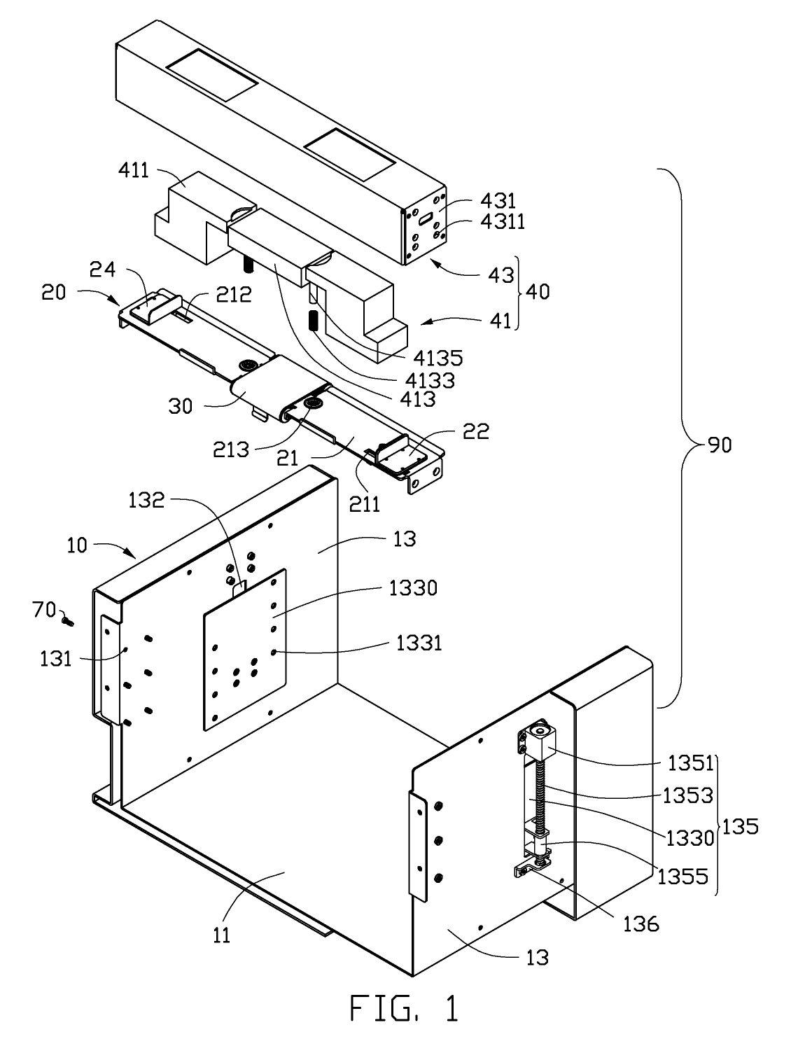

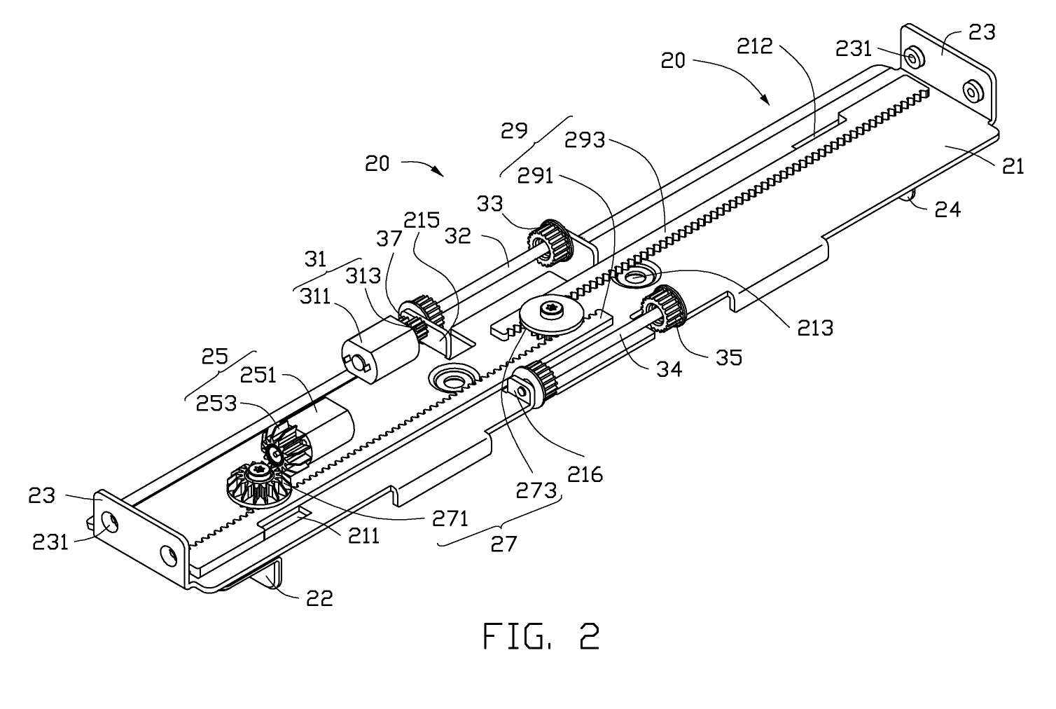

Referring to FIGS. 1-2, the paper adjusting mechanism 20 includes abase plate 21, a rack assembly 29, a first sliding block 22, a second sliding block 24, a gear assembly 27, a second driving mechanism 25, a third driving mechanism 31, and a transferring mechanism 30.

The base plate 21 defines a first sliding slot 211, and a second sliding slot 212, and two through holes 213. The first and second sliding slots 211, 212 are adjacent two opposite edges of the base plate 21. Two mounting pieces 23 are located at the bottom surface of the base plate 21 at the opposite edges. Each mounting piece 23 defines two fixing holes 231. Two first positioning pieces 215 and two second positioning pieces 216 are located on the bottom surface of the base plate 21.

A rack assembly 29 is secured to the bottom surface of the base plate 21 and includes a first rack 291 and a second rack 293 positioned at both sides of the through holes 213. The first sliding block 22 is positioned on a top surface of the base plate 21 and secured to the first rack 291 through the first sliding slot 211. The second sliding block 24 is positioned on the top surface of the base plate 21 and secured to the second rack 293 through the second sliding slot 212.

A gear assembly 27 is secured to the bottom surface of the base plate 21 and includes a first gear 271 and a second gear 273. The first gear 271 meshes with the first rack 291, and the second gear 273 meshes with the first and second racks 291, 293. The second driving mechanism 25 and the third driving mechanism 31 are secured to the bottom surface of the base plate 21. The second driving mechanism 25 includes a second motor 251 secured to the base plate 21 and a first driving gear 253 secured to the second motor 251. The second motor 251 is capable of rotating the first driving motor 251. The first driving gear 253 meshes with the first gear 271. The third driving mechanism 31 includes a third motor 311 and a second driving gear 313. The third motor 311 is secured to the base plate 21 and capable of rotating the second driving gear 313. The second driving gear 313 is secured to the third motor 311.

The transferring mechanism 30 includes two third gears 33, a first positioning shaft 32 secured to the first positioning pieces 215, two fourth gears 35, a second positioning shaft 34 secured to the second positioning pieces 216, and a transferring belt 36. The third gears 33 are secured to the first positioning pieces 215 by the first positioning shaft 32, and the third gears 33 can be rotated about the first positioning shaft 32. The fourth gears 35 are secured to the second positioning pieces 216 by the second positioning shaft 34. The transferring belt 30 surrounds and meshes with the third and fourth gears 33, and actuates when the third and fourth gears 33, 35 are rotated. A pushing block 361 is secured to the transferring belt 30 and move along with the transferring belt 36. A connecting gear 37 is secured to one of the third gears 33 and capable of rotating synchronously with the one third gear 33. The second driving gear 313 meshes with the connecting gear 37.

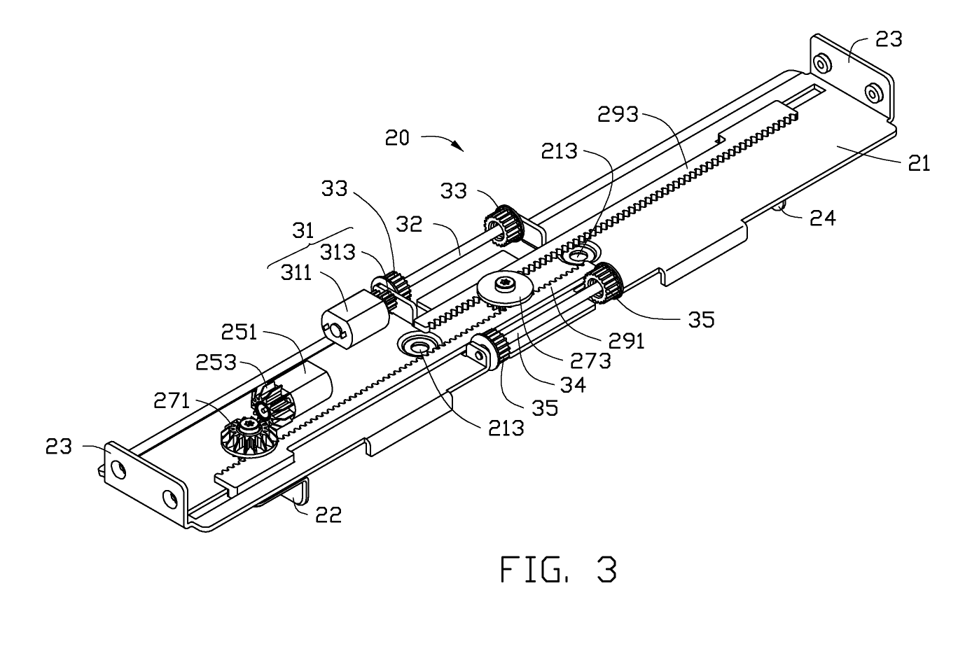

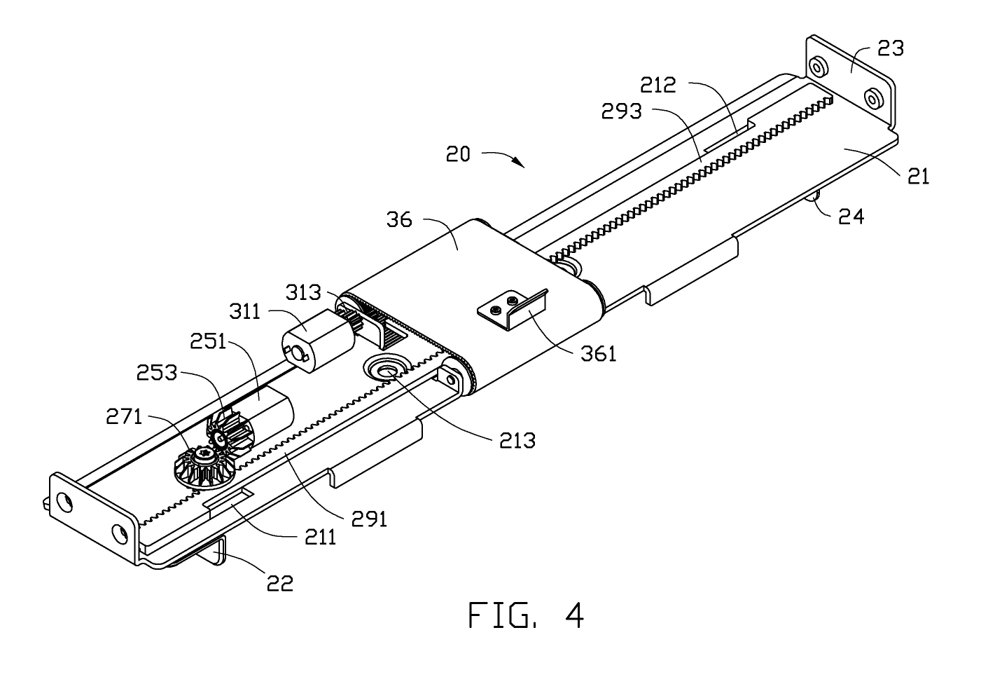

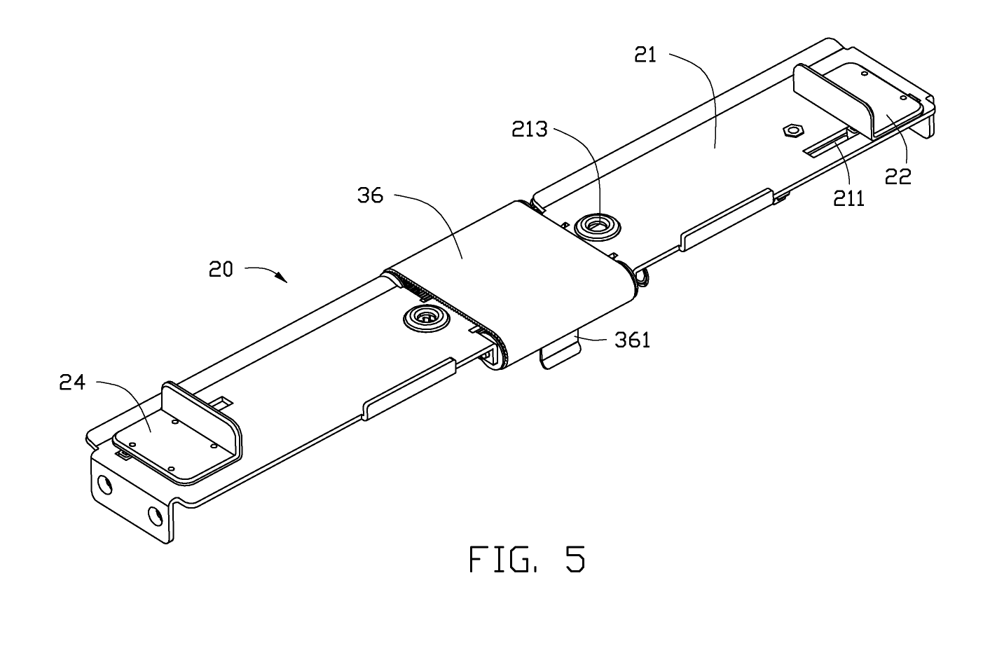

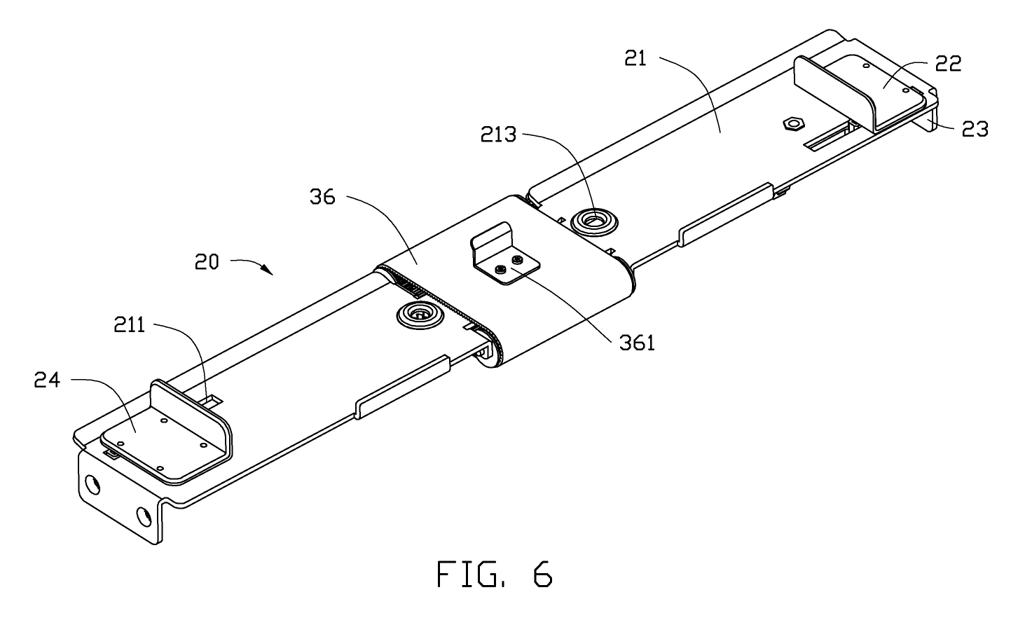

Referring to FIGS. 3-4, the first sliding block 22 and the second sliding block 24 can be slid between a first position (shown in FIG. 3) and a second position (shown in FIG. 4). In the first position, the first and second sliding blocks 22, 24 are slid to abut ends of the first and second sliding slot 211, 212, and the ends are adjacent the mounting pieces 23. In the second position, the first and second sliding blocks 22, 24 are slid to abut on opposite ends of the first and second sliding slots 211, 212, and the opposite edges are away from the mounting pieces 23. Referring to FIGS. 5-6, the transferring belt 36 is moved by the third and fourth gears 33, 35 to move the pushing block 361 from the bottom surface of the base plate 11 to the top surface.

Referring to FIG. 1, the punch mechanism 40 includes a holding case 43 and a punch member 41 configured to be secured in the holding case 43. The holding case 43 includes two opposite sidewalls 431. Each sidewall 431 defines a plurality of locking holes 4311, corresponding to the mounting holes 131 of the bracket 10. The punch member 41 includes a base portion 411 and a moving portion 413. The moving portion 413 is capable of being moved relative to the base portion 411. Two perforation posts 4135 are located on the moving portion 413, corresponding to the two through holes 213 of the base plate 21 of the paper adjusting mechanism 20. Two spring members 4133 fit over the perforation posts 4135. In one embodiment, the spring members 4133 are compressible springs. The outside diameter (OD) of each perforation post 4135 is less than an inside diameter (ID) of each through hole 213, and the OD of each spring member 4133 is greater than the ID of each through hole 213.

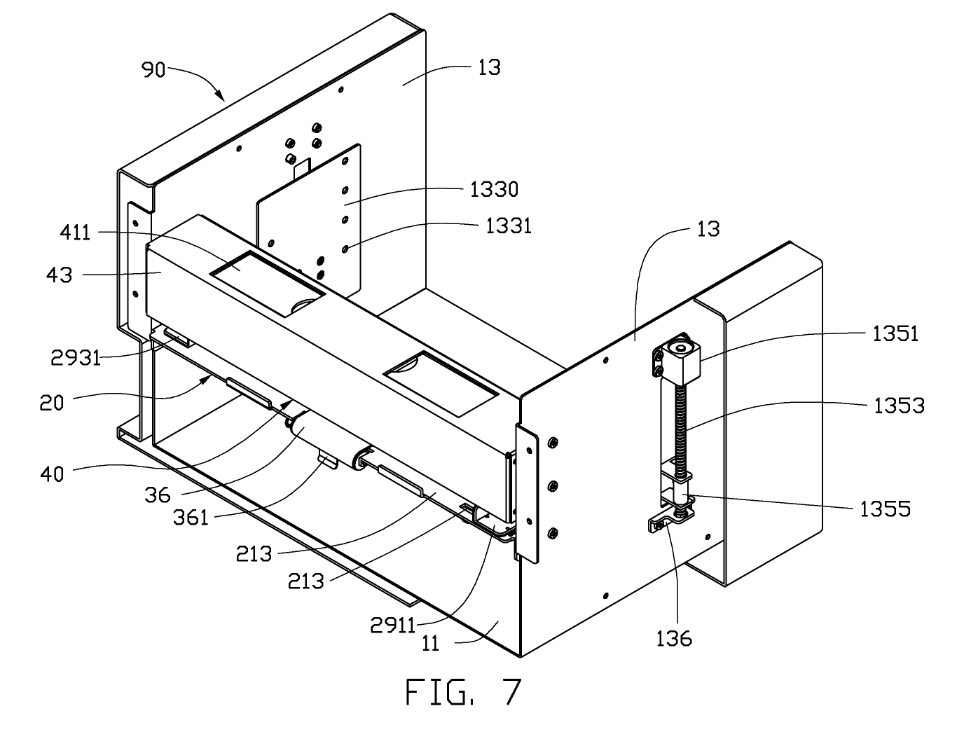

Referring to FIG. 7, in assembly, the paper adjusting mechanism 20 is secured to the bracket 10 between the side plates 13, with two fasteners 70 screwed into two of the mounting holes 131 of each side plate 13 and two of the fixing holes 231 of each mounting piece 23. The punch mechanism 40 is secured to the bracket 10 above the paper adjusting mechanism 20, with another four fasteners 70 screwed into another four mounting holes 131 of each side plate 13 and the four locking holes 4311 of each sidewall 431 of the holding case 43. The perforation posts 415 of punch mechanism 40 correspond with the through holes 213 of the paper adjusting mechanism 20.

Referring to FIG. 8, a plurality of fasteners, such as screws, are screwed into each pair of securing holes 1331 of each sliding piece 133 and paper tray holes (not shown) of each paper tray 60. The paper trays 60 are thus secured to the bracket 10 between the side plates 13, and each paper tray 60 is inclined to the bottom plate 11.

Referring to FIGS. 8-9, a mounting board 50 is secured to the bracket 10. A plurality of hooks 511 is located on the mounting board 50 and secured to a rear wall (not labeled) of the main body 80. A sensor module 53 is secured to the mounting board 50 and capable of detecting the dispensed paper, to control the paper adjusting mechanism 20 and the punch mechanism 40.

Referring to FIG. 10, in use, a file is printed, and paper is dispensed from the main body 80. The sensor module 53 detects the dispensed paper and starts the paper adjusting mechanism 20. The first driving gear 253 is rotated by the second motor 251 of the second driving mechanism 25. The first gear 271 is rotated for meshing with the first driving gear 253. The first rack 291 is slid for meshing with the first gear 271 in a first direction. The second rack 293 is slid in a second direction opposite to the first direction, for the second gear 273 meshing with the first and second racks 291, 293. Therefore, the first and second sliding blocks 22, 24 are slid along with the first and second racks 291, 293. When a distance between the first and second sliding blocks 22, 24 fits the size, such as length or width of dispensed paper, the second motor 251 is stopped. The dispensed paper is placed on the paper adjusting mechanism 20 between the first and second sliding blocks 22, 24 under the punch mechanism 40.

The punch mechanism 40 starts moving the moving portion 411 of the punch member 41 down. The perforation posts 4135 defines holes in the dispensed paper, and then are moved away the dispensed paper. Then the dispensed paper is pushed by the punch mechanism 40.

The transferring mechanism 30 is started. The third motor 311 of the third driving mechanism 31 rotates the second driving gear 313. The connecting gear 37 is rotated for meshing with the second driving gear 313. The third gears 33 are rotated for engaging with the connecting gear 37. The four gears 35 are rotated because the transferring belt 36 meshes with the third and fourth gears 33, 35. Therefore, the transferring belt 36 is moved, and the pushing block 361 move along with the transferring belt 36 and push the dispensed paper to the top of the paper tray 60.

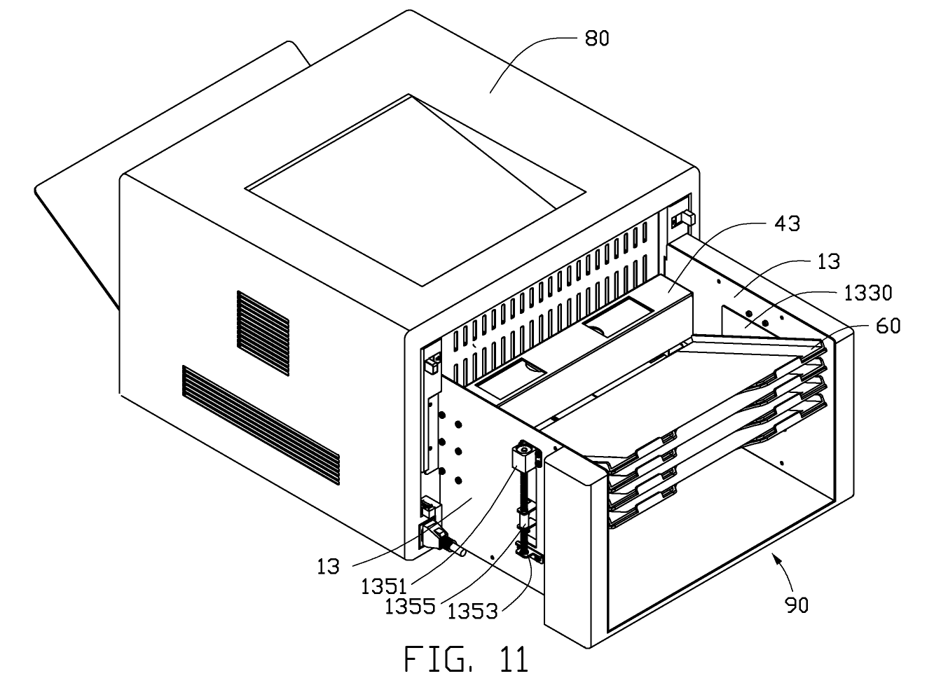

Referring to FIGS. 10-11, if another file is to be printed, the first driving mechanisms 135 on side plates 13 of the bracket 10 are started and the first motors 1351 rotate the corresponding shafts 1353. The sliding members 1355 are slid up on the corresponding shafts 1353. The sliding pieces 133 are slid along with the sliding members 1355 to slide the paper trays 60 up, until another paper tray 60 is positioned in a predetermined position, for receiving the dispensed paper.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A printing device comprising:
a main body capable of printing and dispensing paper; and
a paper holding device secured to the main body, comprising:
a bracket secured to the main body;
a paper tray secured to the bracket for receiving the dispensed paper;
a paper adjusting mechanism capable of aligning the dispensed paper; and
a punch mechanism capable of binding the dispensed paper;
wherein the main body dispenses the paper between the paper adjusting mechanism and the punch mechanism.

2. The printing device of claim 1, wherein the bracket comprises two opposite side plates; a first driving mechanism and a sliding piece are located on both sides of each side plate; each sliding piece is slidably secured to the first driving mechanism; and the paper tray is secured to the sliding pieces.

3. The printing device of claim 2, wherein each of the first driving mechanisms comprises a motor, a shaft, and a sliding member; the shaft is secured to the motor; the sliding member is located on the shaft; the motor is capable of rotating the shaft; and the sliding member is slid on the shaft when the shaft is rotated.

4. The printing device of claim 3, wherein each side plate defines a through opening; and the sliding members are secured to the corresponding sliding pieces via the through openings.

5. The printing device of claim 2, wherein the bracket further comprises a bottom plate between the two opposite side plates; and an angle is defined between the paper tray and the bottom plate.

6. The printing device of claim 1, wherein the punch mechanism comprises a base portion and a moving portion that is movable relative to the base portion; and two perforation posts are located on the moving portion, for forming holes in the dispensed paper.

7. The printing device of claim 1, wherein the paper adjusting mechanism and the punch mechanism are secured to the bracket.

8. The printing device of claim 1, wherein the paper adjusting mechanism comprises two sliding blocks, a rack assembly, a gear assembly, and a second driving mechanism; the two sliding blocks are secured to the rack assembly, the gear assembly is connected to the rack assembly and the second driving mechanism; and the second driving mechanism is capable of rotating the gear assembly to slide the rack assembly and the two sliding blocks in opposite directions for aligning the dispensed paper.

9. The printing device of claim 7, wherein the paper adjusting mechanism further comprises a third driving mechanism, a third gear, a fourth gear, and a transferring belt that meshes with the third gear and the fourth gear; and the third gear meshes with the third driving mechanism.

10. The printing device of claim 9, wherein a pushing block is located on the transferring belt and configured for pushing the dispensed paper to the paper tray.

11. A printing device comprising:
a main body capable of printing and dispensing paper; and
a paper holding device secured to the main body, comprising:
a bracket secured to the main body;
a paper tray secured to the bracket for receiving the dispensed paper;
a paper adjusting mechanism secured to the bracket capable of aligning the dispensed paper; and
a punch mechanism secured to the bracket above the paper adjusting mechanism and capable of binding the dispensed paper;
wherein the paper adjusting mechanism and the punch mechanism is beside the paper tray.

12. The printing device of claim 11, wherein the bracket comprises two opposite side plates; a first driving mechanism and a sliding piece are located on both sides of each side plate; each sliding piece is slidably secured to each first driving mechanism; and the paper tray is secured to the sliding pieces.

13. The printing device of claim 12, wherein each of the first driving mechanism comprises a motor, a shaft, and a sliding member; the shaft is secured to the motor; the sliding member is located on the shaft; the motor is capable of rotating the shaft; and the sliding member is slid on the shaft when the shaft is rotated.

14. The printing device of claim 13, wherein each side plate defines a through opening; and the sliding members are secured to the corresponding sliding pieces via the through openings.

15. The printing device of claim 12, wherein the bracket further comprises a bottom plate between the two opposite side plates; a pair of securing holes is defined in each sliding piece and are configured for engaging the sliding piece with the paper tray; and a line defined by the pair of securing holes of each sliding piece is inclined to the bottom plates.

16. The printing device of claim 11, wherein the punch mechanism comprises a base portion and a moving portion that is movable relative to the base portion; and two perforation posts are located on the moving portion, for forming holes in the dispensed paper.

17. The printing device of claim 11, wherein the paper adjusting mechanism comprises two sliding blocks, a rack assembly, a gear assembly, and a second driving mechanism; the two sliding blocks are secured to the rack assembly, the gear assembly is connected to the rack assembly and the second driving mechanism; and the second driving mechanism is capable of rotating the gear assembly to slide the rack assembly and the two sliding blocks for aligning the dispensed paper.

18. The printing device of claim 17, wherein the two sliding blocks are slid in opposite directions when the gear assembly is rotated.

19. The printing device of claim 11, wherein the paper adjusting mechanism comprises a third driving mechanism, a third gear, a fourth gear, and a transferring belt that meshes with the third gear and the fourth gear; and the third gear meshes with the third driving mechanism.

20. The printing device of claim 19, wherein a pushing block is located on the transferring belt and configured for pushing the dispensed paper to the paper tray.
